(19) United States
(12) Patent Application Publication
(10) Pub. No.: US 2025/0017819 A1
(43) Pub. Date: Jan. 16, 2025

(54) MEDICAMENT CONTAINER

(71) Applicant: WIRTHWEIN MEDICAL GMBH & CO. KG, Mühltal (DE)

(72) Inventors: Thorsten KELLNER, Bayreuth (DE); Jennifer Karina SEIB, Darmstadt (DE); Andreas DUNZ, Mühltal (DE); Thomas JAKOB, Hof (DE)

(73) Assignee: WIRTHWEIN MEDICAL GMBH & CO. KG, Mühltal (DE)

(21) Appl. No.: 18/715,701

(22) PCT Filed: Nov. 30, 2022
(86) PCT No.: PCT/EP2022/083816

§ 371 Date: Jun. 1, 2024

(30) Foreign Application Priority Data
Dec. 1, 2021 (DE) 21211716.2

(51) Int. Cl. A61J 1/14; B65D 1/02; B65D 51/00

(52) U.S. Cl. CPC A61J 1/1412; B65D 1/0246; B65D 51/002

(57) ABSTRACT

A medication container (1) for an active medical ingredient or a medication, the interior (4) of which is accessible via a container opening (6) designed in the manner of a bottle mouth, is intended to provide particularly high-quality and reliable protection against tampering with its contents. For this purpose, according to the invention, a number, preferably three, of circumferentially attached outer beads (12, 16) are arranged on the outside of the container opening, wherein the lowest or proximal outer bead (16) as seen in the direction of the mouth opening (14) is designed as a limiting outer bead (16) of and has a bead width (W) of at least 150% of the bead width (w) of the adjacent outer bead (12).

### FIELD

This disclosure relates to a medication container for an active medical ingredient or a medicine, the interior of which is accessible via a container opening designed in the manner of a bottle mouth.

### BACKGROUND

Medications, especially for treatment in highly specialized or complex therapies, are usually provided in active ingredient or medication containers, also known as containers or vials. Such a drug container is usually designed in the form of a vial and comprises an interior in which the drug or active ingredient is held and which is accessible via a container opening designed in the form of a bottle mouth. From such a container or receptacle, the active ingredient is then transferred via suitable transfer systems for the actual administration to suitable systems such as a syringe or an intravenous line that provides fluid access to the patient's circulation.

Particularly in the case of comparatively complex therapies or medication plans and in view of the fact that medications with an extremely high dose price have recently been released, it may be urgently desirable or even necessary to ensure that the medications have not been exposed to manipulation or prior removal from the container before they are administered. Therefore, medication containers of the aforementioned type may be provided with a so-called originality closure. The closure system of such a medication container can be provided with an additional external closure element in the form of a disposable closure. This disposable closure, which can for example comprise a tear-off or sealed sealing lid, allows problem-free and reliable identification of whether or not the container has already been used for liquid transfer or whether the contents may have been tampered with. This makes it easier to determine whether the container has already been “opened” and should therefore be used for further liquid removal until it is completely empty and should therefore be disposed of, or whether the contents have even been accessed without authorization.

### BRIEF SUMMARY

This disclosure is therefore based on the object of providing a medication container of the above-mentioned type which offers particularly high-quality and reliable protection against tampering with its contents.

This object is achieved in accordance with this disclosure by arranging a number, preferably three, of circumferentially attached outer beads on the outside of the container opening, the lowermost or proximal outer bead as seen in the direction of the mouth opening being designed as a limiting outer bead and having a bead width of at least 150% of the bead width of the adjacent outer bead.

In this context, “circumferential” is to be understood in particular as meaning that each of the aforementioned external beads has the contour of a self-contained annular body running around the container opening. This is to be distinguished in particular from the threads that are commonly found in beverage bottles, for example, in the area of the bottle mouth, by means of which the closure cap can be screwed onto the bottle mouth. Such a thread has thread ribs that move longitudinally around the bottle neck finish when it is completely wrapped around it, forming the so-called thread height. Such a thread-like design is not to be regarded as “circumferential” in the aforementioned sense.

Advantageous embodiments of this disclosure are the subject of the subclaims.

This disclosure is based on the consideration that the tamper protection usually used in medication containers of the type mentioned, for example in the form of the tear-off or sealed sealing lids mentioned, certainly provides reliable tamper protection or at least a reliable indication of whether access has been gained to the contents of the container in the event of access in the area of the lid itself. In contrast, however, the end area of the lid, i.e. the “lower” edge of the cap pushed onto the bottle mouth, is considered a weak point. To take this into account, the bottle mouth or container opening should be specifically designed to provide protection against tampering from the lower end edge. For this purpose, the bottle mouth has a “lower” or proximal outer bead that is thickened or widened in com-parison to the other outer beads, in the manner of a protective or safety ring, which can cover the lower edge of the pushed-on cap and thus protect it from unwanted access.

In other words, it is therefore intended that the outer beads are each designed to be functionally different from one another. The (one or more) “upper” outer beads, i.e., those arranged adjacent to the mouth opening of the container, serve as latching or hooking elements for interacting with corresponding latching or hooking elements on the container cap, so that the latter can be securely and firmly attached to the bottle mouth. The “lowest”, proximal outer bead, on the other hand, serves as a securing element to prevent un-wanted access to the fitted closure cap from below, and accordingly it should preferably be wide enough so that it covers the ensemble of the mouth area of the container and the fitted closure cap radially sufficiently, preferably completely. For this purpose, the outer limiting bead preferably has a bead width of at least twice, preferably about three times, the bead width of the adjacent outer bead positioned further “up” in the direction of the mouth opening.

The outer beads can be designed in segments, i.e., the respective outer bead can be formed by a number of bead segments arranged rotationally sequentially one behind the other around the bottle mouth, which are positioned sequentially at a distance from each other, i.e., forming a gap. Preferably, however, the outer beads are designed for interaction with the associated components, for example latching elements on the closure cap, in any rotational orientation; advantageously, therefore, at least one of the outer beads is completely circumferential.

The desired security function, with regard to protection against tampering, can be achieved particularly reliably if the lower side of the outer limiting bead, which faces away from the mouth opening and can therefore also be accessed when the closure cap is in place, is relatively flat and abuts the container wall at as right an angle as possible. For this purpose, in an advantageous design, the outer limiting bead has a straight flank on the under-side that is tilted with its normal to the longitudinal axis of the container opening by no more than 10°.

In a particularly preferred embodiment, the medication container is equipped with particularly extensively coordinated components of its closure system. For this purpose, the container opening is advantageously closed with a push-on bounce cap provided with a sealing element, on the outer circumference of which a number of latching elements that can be brought into latching engagement with one of the outer beads are arranged, whereby the bounce cap closes axially on the limiting outer bead when fully pushed onto the container opening. In addition, the bounce cap should not protrude laterally or radially too far or preferably not at all beyond the outer limiting bead. In consequence, a system is created in which the (proximal) outer limiting bead, also referred to as the “3rd rib”, covers the bounce cap from the underside and thus prevents the closure system from being levered open or easily released by access from below. The outer limiting bead determines the tamper evidence to a considerable extent.

In a further or alternative advantageous embodiment, a frontal area of the or each latching element is in contact with a contact surface arranged on the mouth-side flank of the outer limiting bead when the cap is fully pushed onto the container opening. In this particularly preferred embodiment, the limiting outer bead can thus be predetermined analogously to a stop surface that defines the end position of the closure cap to be applied in the axial direction. This automatically provides the desired downward covering function.

Advantageously, the components are particularly adapted to the intended functionality in terms of their choice of material: the bounce cap should be suitable for the intended snap-on or latching connection on the container opening or a latching edge surrounding it, and, in particular, be designed to be correspondingly rigid. In contrast, the sealing element should be suitably designed with regard to the desired easy deforming when creating the sealing effect. Accordingly, the bounce cap is preferably made of a plastic, particularly preferably polypropylene (PP), a polyolefin, cyclo-olefin copolymer (COC), cyclo-olefin polymer (COP), or polycarbonate. In an alternative or additional advantageous embodiment, the sealing plug is made of rubber or TPE.

For particularly safe and reliable handling, the medication container should be specially secured once the closure system has been attached. For this purpose, it advantageously comprises a further component in the form of a locking ring that can be slid onto the pop-up cap and can be fixed to the pop-up cap by means of a number of snap-on ribs formed on the inside and positioned at the ends. After the bounce cap has been fitted, in which the latching elements arranged on its outer circumference are brought into engagement, i.e., “snapped on” or engaged, with the outer bead attached to the container opening when it is pushed onto the container mouth, the retaining ring can be pushed onto the bounce cap. It encloses the latching elements in a ring shape from the outside and thus fixes them in the latched position; it is then no longer possible to move outwards and thus release the latching mechanism.

In a particularly preferred embodiment, which is regarded as independently inventive, an RFID chip is arranged on the bounce cap, particularly preferably on its ring lid. This can be provided with a code or identifier that individually identifies the medication container and/or can contain further information regarding the contents, for example the composition of the medication or active ingredient, an eventual expiry date or the like. In particular, since such a chip can also be read without contact, automated handling of the medication container and its contents, up to fully or partially automated medication production in mixing systems or the like, can be achieved.

In a further particularly preferred embodiment of the medication container, for providing a tamper-evident closure it comprises sealing plate fixedly formed on the outside of the retaining ring such that it can be torn off therefrom.

The tamper-evident closure advantageously comprises a connecting segment that extends between the tear-off ring and the sealing plate and is molded onto the tear-off ring and/or the sealing plate via a number of predetermined breaking points in order to form a fixed connection with the bounce cap.

The use of a closure system of the aforementioned type for a medication container is considered to be independently inventive.

The advantages achieved with the invention consist in particular in the fact that by equipping the container opening designed as a bottle mouth with an additional outer limiting bead designed in the manner of a further or preferably 3rd rib and its widened design compared to the other outer beads already provided, a particularly effective protection against manipulation “from below” can be achieved. In addition, it has surprisingly turned out that such a widened lower outer bead can also be used very favorably as a suitable attack surface for automated handling of the medication container. In particular, the outer bead can serve as a support surface on which suitable lifting elements can act, for example to support the container downwards during filling. This allows the container to be held in place particularly securely during filling or also during a subsequent closing process, making it particularly safe to handle.

### BRIEF DESCRIPTION OF THE DRAWINGS

An embodiment of the invention is explained in more detail with reference to a drawing. It shows:

FIG. 1 shows a medication container closed with a closure system,

FIG. 2 shows perspective view of the container opening of the medication container according to FIG. 1,

FIG. 3 shows the container opening of the medication container according to FIG. 1,

FIG. 4 shows the medication container according to FIG. 1 with associated closure system in explosion view,

FIG. 5 shows a sealing element of the medication container according to FIG. 1,

FIG. 6 shows the bounce cap of the closure system of the medication container according to FIG. 1,

FIG. 7 shows a sequence of steps in attaching the closure system to the medication container according to FIG. 1, and

FIG. 8 shows an alternative embodiment of a medicine container.

Identical parts are marked with the same reference numerals in all figures.

### DETAILED DESCRIPTION

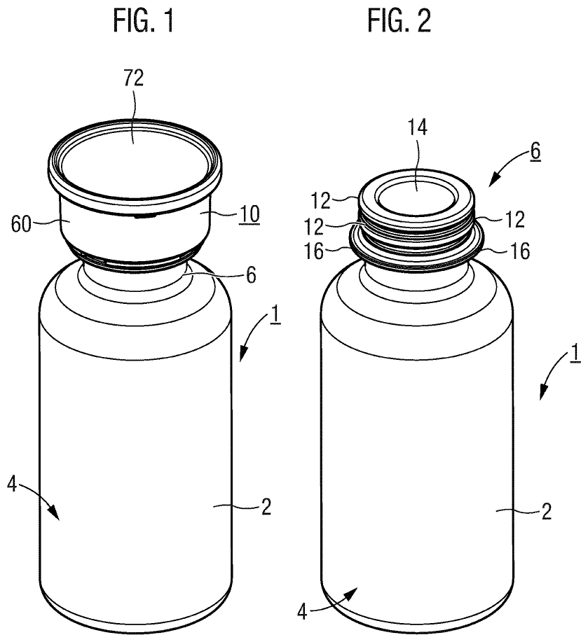

The medication container 1 as shown in FIG. 1, also known as a container or vial, is designed in the form of a small bottle. It comprises an interior 4 enclosed by a container wall 2, in which the medication or active ingredient is held. In the embodiment shown, the container wall 2 is made of a suitably selected plastic with or without a barrier layer. A “medical grade” plastic is particularly preferred, preferably of the material classes COP, COC, such as COP variants 690R®, 790R®, COC variants Topas® 8007S-04, 6013S-04, 6015S-04. The plastic is particularly preferably selected with regard to the criteria transparent, unbreakable, little to no interaction with the intended medication, medical grade, in particular generally usable as a glass substitute, individually or in combination with each other. The interior 4 is accessible via a container opening 6 designed in the manner of a bottle mouth.

The medication container 1 is designed in particular for holding active substances or for which any loss of material due to unintentional release into the environment or surroundings should be avoided as far as possible. This may be the case, for example, for toxic substances, substances that are hazardous to health or otherwise dangerous for the persons handling them, or for particularly expensive substances or active ingredients, such as those increasingly used in modern therapies. In order to keep such undesirable material losses particularly low, the medication container 1 is equipped with a closure system 10 that closes the container opening 6 and is designed to ensure a particularly high level of tightness on the one hand and particularly effective protection against tampering on the other.

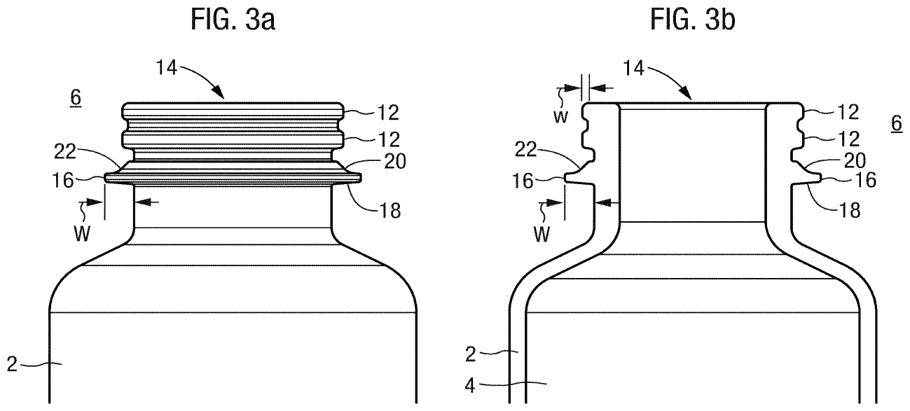

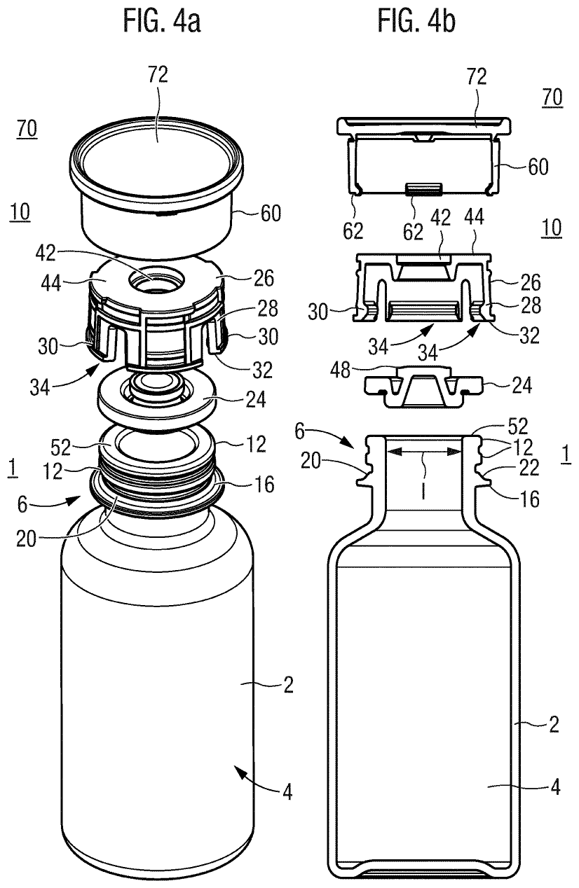

As can be clearly seen from the perspective view in FIG. 2 and the longitudinal sectional view in FIG. 3, the container wall 2 of the medication container 1 is provided in the region of the container opening 6 with a number of outer beads 12, two in the embodiment shown, arranged around it as a fastening element for the closure system 10. A first of these outer beads 12 is arranged directly adjacent to the mouth opening 14 of the container 1; a second outer bead 12, on the other hand, is located at a distance from the mouth opening 14. In the following, in relation to the longitudinal direction of the container opening designed in the manner of a bottle mouth, such a positioning further away from the mouth opening is referred to as “bottom” or “proximal”, whereas a positioning more towards the mouth opening 14 and thus towards the free, open end of the container opening 6 is referred to as “top” or “distal”.

As can be clearly seen in particular from the longitudinal sectional view in FIG. 3b, the two upper outer beads 12 attached circumferentially to the container opening 6 have an approximately or completely identical bead width w. This design is chosen with regard to the intended use of these outer beads for latching or fixing with associated latching or snap-in elements of the closure system 10. In contrast, the lowest or proximal outer bead 16, as seen in the direction of the mouth opening, is designed with a bead width W that is significantly larger than that of the outer beads 12, i.e., significantly more than at least 150% of the bead width w of the adjacent outer bead 12, in order to improve protection against tampering.

In the embodiment example, as can be clearly seen from the representation in FIG. 2, the outer beads 12, 16 are designed to be completely circumferential. In other embodiments, the outer beads 12, 16 could be fully or partially segmented, i.e., comprise several segments which follow one another in the rotational direction and are positioned at a distance from one another, forming gaps between them.

A further particularly preferred aspect of the present invention relates to the cross-sectional profile of the limiting outer bead 16. As can be seen from the illustration in FIG. 3, the limiting outer bead 16 has, on its lower side facing away from the mouth opening 14, a largely straight flank 18 which is tilted with its normal towards above the longitudinal axis of the container opening 6 by a maximum of 10°. On the one hand, this design achieves a particularly reliable flat covering of the closure system 10 arranged above, while on the other hand forming a particularly favorable and suitable contact surface for automated handling purposes.

Furthermore, the limiting outer bead 16 has a flank 20 on its upper side facing the mouth opening 14, which, as explained below, is specifically designed for a favorable interaction with the closure system 10. In particular, the upper flank 20 of the limiting outer bead 16 forms a contact surface 22. The intended parameterization of the components, in particular the width of the limiting outer bead selected comparatively large compared to the overlying outer beads 12 of at least 150%, but preferably about three times, ensures that the contact surface 22 is sufficiently large so that it can form a functional contact surface for associated components.

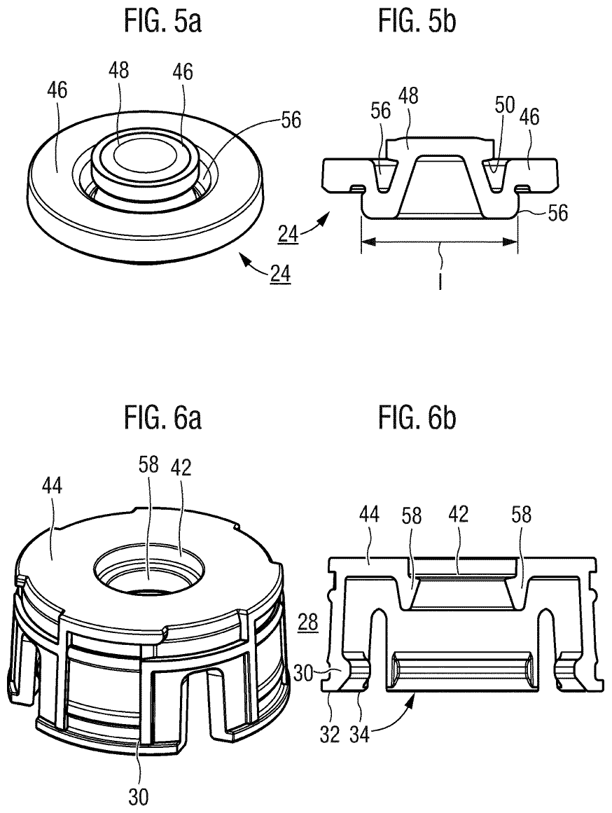

In FIG. 4, the mouth area of the medication container 1 together with the associated closure system 10 is shown in exploded view, in FIG. 4a in lateral plan view and in FIG. 4b in longitudinal section. The closure system 10 comprises as essential components a sealing element 24 designed as a closure plug for closing the container opening 6 and a fixing cap 26, with which the sealing element 24 can be firmly attached to the container opening 6. Adapted to the outer beads 12, the fixing cap 26 is designed as a bounce cap 28, on the outer circumference of which a number of snap hooks or latching elements 30 that can be brought into engagement with the respective outer bead 12 are arranged. When attaching the bounce cap 28, it can thus be pushed or bounced onto the container opening 6, whereby the latching elements 30 are first bent outwards through the respective outer bead 12 and then, after being pushed on further, engage behind the outer bead 12 and latch with it in the manner of a snap connection. Furthermore, with regard to its dimensioning as viewed in the longitudinal direction of the container opening 6, the bounce cap 28 is adapted to the outer contour thereof formed by the outer beads 12, 16 in such a way that the frontal area 34 of the or each latching element 30 formed by the end edge 32 of the bounce cap 28 rests against the contact surface 22 arranged on the mouth-side flank 20 of the limiting outer bead 16 when the bounce cap 28 is fully pushed onto the container opening 6.

This system, i.e., in particular the bead width W, which is at least 150% greater than the outer beads 12, enables the frontal area 34 of the respective latching element to rest flatly on the contact surface 22. This enables a particularly mechanically stable overall contact between the components, which makes manipulation of the system locked in this way considerably more difficult or even completely impossible. In particular, this choice of parameters, which is considered to be inventive in its own right, allows the contact surfaces of the two components to be matched to each other in such a way that there are no or only very few opportunities for manipulation tools, such as levers, to attack, as might otherwise be the case, for example, due to gaps or edges.

Furthermore, the aforementioned choice of parameters, namely the choice of the bead width W of the limiting outer bead 16 in comparison to the bead width w of the outer bead 12, enables a consistent functional separation of the associated components: for the outer bead 12, it is intended that the latching elements 30 can be slid over it when attaching the bounce cap 28, so that the intended locking can take place later. On the other hand, such sliding over the limiting outer bead 16 should be avoided, as this should merely provide the support surface for the frontal area 34 in the manner of an end stop. In addition, according to one aspect of the invention, this is further facilitated by the flank 18 provided, which further improves the desired planar contact with the end region of the latching elements 30 and can also serve as a guide surface.

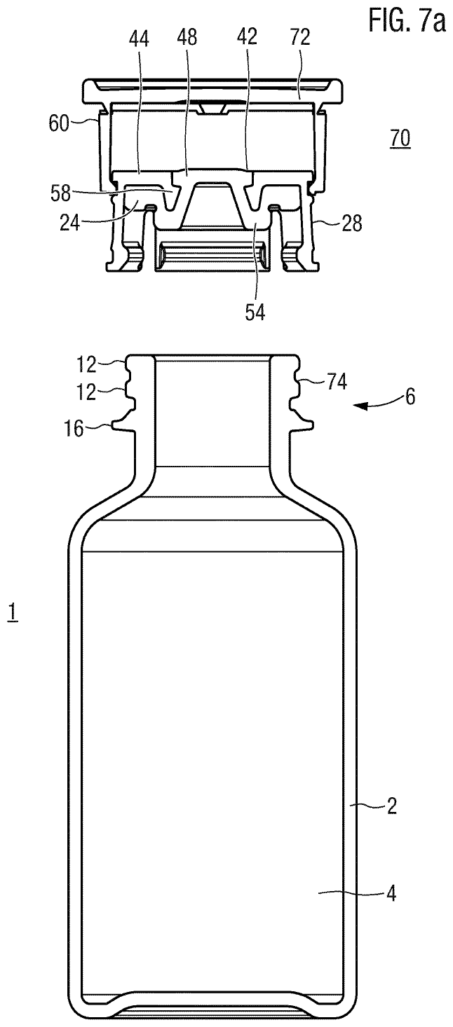

The bounce cap 28 comprises a ring lid 44 having a central opening 42. By contrast, the sealing element 24, which is designed in one piece and is shown enlarged in FIG. 5, comprises a closure plate 46 in the manner of a basic element, on the first plate side of which a thickening 48 is formed which completely fills the central opening 42 of the ring lid 44 and can be brought into engagement with the latter in a latching manner. In its connection area with the closure plate 46, the thickening 48 is provided with a circumferential groove 50 forming an undercut. The one-piece sealing element 24 is, also with regard to the desired sealing purposes, made of a suitable and also comparatively soft and easily deformable material, in the embodiment example of rubber or TPE, preferably “medical grade”. This choice of material also ensures that the sealing element 24 can be pierced using a suitable instrument, such as a hollow needle, if necessary, i.e. if active ingredient is to be removed from the medication container 1. Using these material properties, in particular the deformability, the sealing element 24 can be approximately firmly connected to the bounce cap 28 by inserting the thickening 48 into the opening 42 in the ring lid 44 and the circumferential edge of the opening 42 then engages in the groove 50 and thus fixes the sealing element 24 to the bounce cap 28.

In an advantageous manner, the sealing element 24 contributes to sealing of the container opening 6 in two ways. On the one hand, a sealing effect is achieved, which is quite com-parable with known systems, in that in the assembled system the closure plate 46, which is suitably adapted in its dimensions, in particular its outer diameter, to the mouth edge 52 of the container opening 6, is pressed onto the mouth edge 52 with its edge of the sealing element 24 by means of the bounce cap 28, which can be snapped onto the mouth edge 52. As a result of this axial force effect seen in relation to the longitudinal axis of the container opening, the closure plate 46 can already develop a sealing effect due to the de-formability of the material. In addition, however, the provision of radial force components, i.e., contact pressure forces that press the sealing element 24 in the radial direction against the inside of the container wall 2 in the area of its mouth, is also provided in the present case for a particularly increased sealing effect overall.

For this purpose, a radial sealing element 54 is formed on the second plate side of the closure plate 46. The cross-sectional shape of the radial sealing element 54 is adapted to the cross-sectional shape of the container opening 6 in the mouth area (in the embodiment example, both are round). In terms of its dimensions, it is also adapted to the clear width 1 of the container opening 6 and, with regard to the deformability of the material of the sealing element 24, is slightly larger than the clear width 1 of the container opening 6. As a result, when the radial sealing element 54 is inserted into the container opening 6, taking into ac-count the deformability of its material, a surface pressure or pressing effect is created on the inner wall of the container in the area of the container opening. With regard to common standards and usual norms for such components, the container opening can be suitably selected and dimensioned; for example, its clear width can be suitably matched to the standard dimension “13 neck” (corresponds to an outer diameter of the container opening of 13 mm) or to the standard dimension “20 neck” (corresponds to an outer diameter of the container opening of 20 mm).

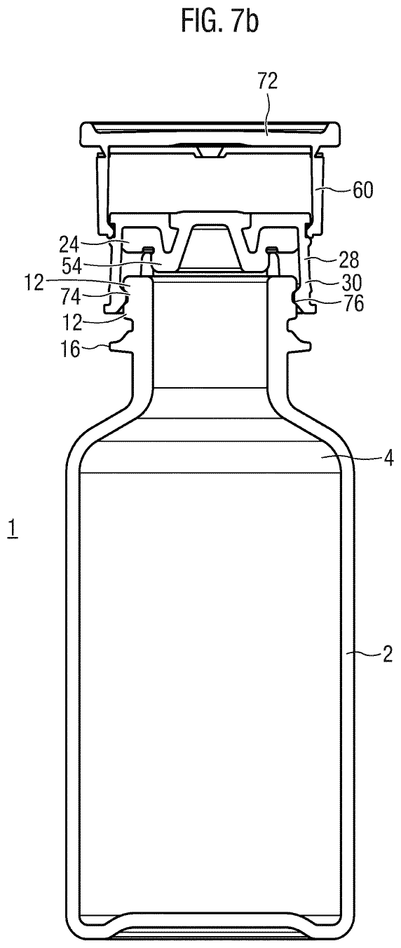

The sealing element 24 is advantageously designed for an even further improved sealing effect in the radial direction. For this purpose, the shape is selected such that the central area of the sealing element 24 forming the thickening 48 is surrounded by a circumferential groove or trench-like deepening 56 extending deep into the closure plate 46. The deepening 56 can also completely penetrate the material thickness of the closure plate 46, so that the sealing element 24 is multi-component in this embodiment. Adapted to this, the bounce cap 28, as shown in FIG. 6a in perspective view from below and in FIG. 6b in enlarged longitudinal section, has a reinforcing ring 58 formed on the underside of the ring lid 44 and running around the opening 42. During assembly of the two components, this reinforcing ring 58 is inserted into the deepening 56 of the sealing element 24. The dimensions are coordinated in such a way that the reinforcing ring 58 gives the radial sealing element 54 of the sealing element 24 increased strength and rigidity towards the outside, i.e. in the radial di-rection, and thus further improves the radial seal. In particular, the appropriately selected dimensions of the reinforcing ring 58 can slightly deform the radial sealing element 54 more or less towards the outside and thereby generate an additional contact pressure force in the radial direction on the inner wall of the medication container 1 in the region of the container opening 6.

In the embodiment example, the bounce cap 28 is made of a suitably selected plastic, namely polypropylene (PP), a polyolefin, cyclo-olefin copolymer (COC), cyclo-olefin polymer (COP) or polycarbonate.

As a further component, as can again be seen from the illustration in FIG. 4, the closure system 10 comprises a retaining ring 60 that can be pushed onto the bounce cap 28. After the bounce cap 28 has been bounced open and latched with the outer beads 12, this ring can be pushed onto the bounce cap 28 from the outside, embracing it. This fixes the latching elements 30 radially so that they can no longer move outwards. This means that the latching of the bounce cap 28 with the outer bead 12 can no longer be easily released and is therefore fixed.

For its part, the retaining ring 60 has a number of snap ribs 62 formed on the inside and positioned at the ends, by means of which it can be fixed to the bounce cap 28 in a latching manner.

Furthermore, the medication container 1 closed with the closure system 10 has a tamper-evident closure 70 as a component. This is intended to ensure, in the manner of a disposable closure, that the user can easily and reliably determine whether the medication container 1 has already been used for liquid transfer or not, i.e., whether active ingredient has already been removed or not. It therefore makes it easier to determine whether the container has already been “opened” and should therefore be preferably used for further liquid removal until it is completely empty and should therefore be disposed of. The tamper-evident closure 70 is designed as a sealing plate 72 molded onto the retaining ring 60. The sealing plate 72 is dimensioned and positioned in such a way that, when fitted, it completely covers the central opening 42 of the ring lid 44 and thus the exposed surface of the sealing element 24 accessible above it. To access the inside of the medication container 1, i.e., to remove the active ingredient, the sealing plate 72 must therefore first be removed so that the sealing element 24 can be pierced.

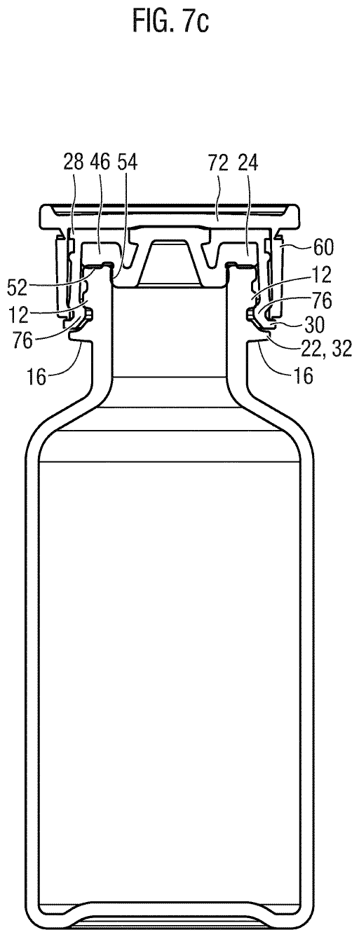

The attachment of the closure system 10 to the medication container 1 is shown in FIG. 7 using a sequence of steps. In a first step, shown in FIG. 7a, the closure system 10 is first pre-assembled in a sequence that is regarded as independently inventive. For this purpose, the tamper-evident closure 70 is connected to the bounce cap 28 and the thickening 48 of the sealing element 24 is brought into a latching connection with the opening 42 of the ring lid 44 of the bounce cap 28.

Starting from this pre-assembled state, the intermediate step shown in FIG. 7b can be carried out under certain circumstances and as required. In this intermediate step, the embodiment provided in the embodiment example is used, in which two circumferential outer beads 12 in the form of a double bead are provided on the outside in the mouth area of the container opening 6. In this embodiment, the outer beads 12 are separated from each other by a groove 74 running between them. In such a construction way, it is possible to push the closure system 10 onto the container opening 6 in a first step only to the extent that the latching hooks 76 formed on the latching elements 30 in each case engage only in the groove 74 and lock the system there at next. In this intermediate state, which is shown in FIG. 7b, the sealing element 24 does not yet close the container opening 6, as the radial sealing element 54 has not yet penetrated into the interior of the container opening 6. Instead, a circumferential annular gap that is still open is formed between the radial sealing element 54 and the mouth of the container 1 in this state. Together with the circumferential intermediate spaces between the individual latching elements 30 of the bounce cap 28, there is therefore still a gas-side connection between the interior 4 of the medication container 1 and the external environment in this state.

This position can be used, for example, for freeze-drying, also known as lyophilization or sublimation drying, of the active ingredient in the medication container 1. This is now a widely used process for the gentle drying of products that is used for a variety of medications or active ingredients in order to preserve them. In such a freeze-drying process, it may be necessary to be able to release the resulting gases or vapors, in particular water vapor, into the environment, and the positioning of the components shown in FIG. 7b offers such a possibility.

After this intermediate step, or possibly also directly after the pre-assembly shown in FIG. 7a, if no such intermediate step is required, the sealing process is then completed, and the system is transferred to the fully sealed state shown in FIG. 7c. For this purpose, the bounce cap 28 is first moved further over the container opening, so that the sealing element 24 now penetrates with its radial sealing element 54 into the container opening 6 until the closure plate 46 rests with its outer edge on the mouth edge 52 of the container 1 and then, with annular deformation of the closure plate 46 as seen in the longitudinal direction of the container opening 6, the latching hooks 76 of the bounce cap 28 engage below the second or lower outer bead 12. The retaining ring 60 is then moved downwards so that it engages around the outside of the bounce cap 28. This locks the latching elements 30 in their position and the medication container 1 is securely closed in the position shown in FIG. 7c.

From this illustration, i.e. in the fully assembled state, it can also be clearly seen once again how the lower limiting outer bead 16 secures the slid-on closure system 10 at the bottom and thus increases the protection against tampering. Due to the significantly increased bead width W of the limiting outer bead 16 compared to the outer beads 12, the open end area of the components pushed onto each other (bounce cap 28, retaining ring 60) is covered from below and thus protected against tampering access. In addition, the edge 32 of the bounce cap lies against the contact surface 22, so that further support can be provided here.

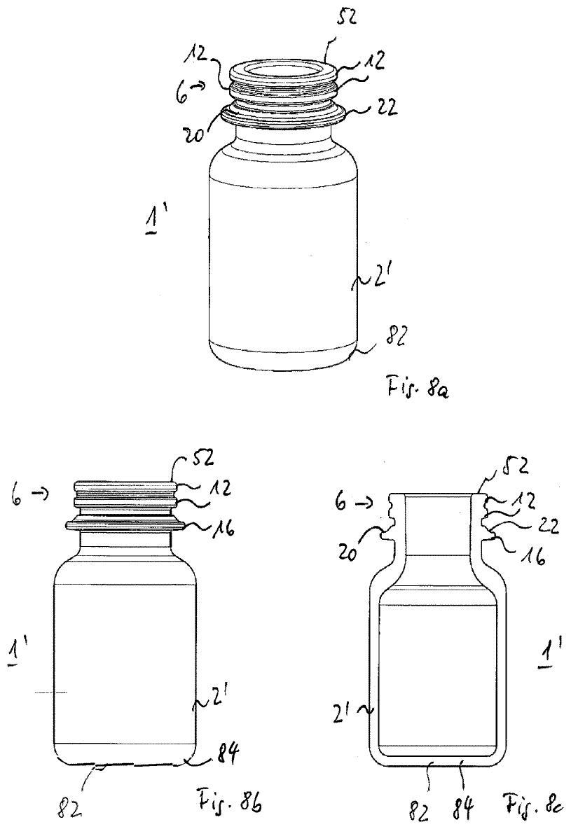

As can also be clearly seen from the representation of the bounce cap 28 in FIG. 6a or FIG. 8, an RFID chip 80 is arranged on its ring lid 44, preferably injection-moulded into it, in an embodiment which is regarded as independently inventive. The RFID chip 80 can be provided with a code or identifier that individually identifies the medication container and/or can contain further information regarding the contents, for example the composition of the medication or active ingredient, a possible expiry date, a batch number, the raw materials used, production and manufacturing information of the manufacturer or the like. In particular, since such a chip can also be read without contact, automated handling of the medication container 1 and its contents, up to fully or partially automated medication production in mixing systems or the like, can be achieved.

FIG. 8 shows an alternative embodiment of a medication container 1′ in perspective view (FIG. 8a), in side view (FIG. 8b) and in longitudinal section (FIG. 8c). This alternative medication container 1′ is largely identical in design to the medication container 1 described above, in particular with regard to the design in the area of the container opening 6 and the outer beads 12 provided there and the additionally provided limiting outer bead 16. However, in accordance with an aspect which is regarded as independently inventive, the base region 82 of this Medication container 1′ is designed as a flat, rectilinear base plate 84 which forms a straight line in longitudinal section, in contrast to conventional designs of such containers, which usually have an inwardly directed curvature. In particular, this makes advantageous use of the degrees of freedom in the geometric design provided by the intend-ed choice of material for the container wall 2′, especially since such a design enables volume advantages and thus additional material savings.

### LIST OF REFERENCE SYMBOLS

1 Medication container
2 Container wall
4 Interior
6 Container opening
10 Closure system
12 Outer bead
14 Mouth opening
16 Limiting outer bead
18 Lower flank
20 Upper flank
22 Contact surface
24 Sealing element
26 Fixing cap
28 Bounce cap
30 Latching elements
32 Edge
34 Frontal area
42 Opening
44 Ring lid
46 Closure plate
48 Thickening
50 Groove
52 Mouth edge
54 Radial sealing element
56 Deepening
58 Reinforcing ring
60 Retaining ring
62 Snap ribs
70 Tamper-evident closure
72 Sealing plate
74 Groove
76 Latching hook
80 RFID chip
82 Base region
W Bead width
W Width of the limiting outer bead
D Diameter
L Clear width

1. A medication container for an active medical substance or a medicament, an interior of which is accessible via a container opening which is designed in the manner of a bottle mouth and on an outside of which three or more circumferentially attached outer beads are arranged, wherein a lowest or proximal outer bead as seen in the direction of the mouth opening is designed as a limiting outer bead and has a bead width of at least twice the bead width of an adjacent outer bead.

2. The medication container according to claim 1, in which the limiting outer bead has a bead width of at least three times the bead width of the adjacent outer bead.

3. The medication container according to claim 1, wherein at least one of the outer beads is designed to be completely circumferential.

4. The medication container according to claim 1, wherein a lower side of the limiting outer bead facing away from the mouth opening has a generally straight flank which is tilted with its normal relative to the longitudinal axis of the container opening by at most 10°.

5. The medication container according to claim 1, wherein the container opening is closed with a push-on bounce cap which is provided with a sealing element, the bounce cap including one or more latching elements on an outer circumference of the bounce cap, wherein each latching element can be brought into latching engagement with one of the outer beads, and wherein a frontal area of each latching element, in the is fully permanent pushed onto the container opening state of the bounce cap terminates axially on the limiting outer bead.

6. (canceled)

7. The medication container according to claim 5, wherein the bounce cap is made of a plastic.

8. The medication container according to claim 5, wherein the sealing element is made of rubber or TPE.

9. The medication container according to claim 5, wherein the container opening is closed with a closure system which, in addition to the bounce cap, comprises a locking ring which can be pushed onto the bounce cap and can be fixed in a latching manner to the bounce cap by one or more snap-on ribs formed on an inside of the locking ring and positioned at the ends.

10. The medication container according to claim 9, wherein an RFID chip is arranged on a ring lid of the bounce cap.

11. The medication container according to claim 9, wherein a sealing plate is firmly molded on an outside of the locking ring and can be torn off from the locking ring to form a tamper-evident closure.

12. The medication container according to claim 7, wherein the bounce cap is made of polypropylene (PP), a polyolefin or polycarbonate.

13. The medication container according to claim 2, wherein at least one of the outer beads is designed to be completely circumferential.

14. The medication container according to claim 10, a sealing plate is firmly molded on an outside of the locking ring and can be torn off from the locking ring to form a tamper-evident closure.
